(19) United States
(12) Patent Application Publication
(10) Pub. No.: US 2001/0044760 A1
(43) Pub. Date: Nov. 22, 2001

(54) Product selling system, ordering device, order receiving device, order processing device, product selling method, and storage medium

(75) Inventor: Takeshi Oomori, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/860,630

(22) Filed: May 21, 2001

(30) Foreign Application Priority Data
May 19, 2000 (JP) 148795/2000

(51) Int. Cl. G06F 17/60

(52) U.S. Cl. 705/27

(57) ABSTRACT

Provided are an orderer terminal 10, 11 performing ordering a product on the basis of product information and reception information, a reception computer 20 generating the reception information identifying an orderer in the order of reception on the basis of product information transmitted from the orderer terminal 10, 11, and transmitting it to the orderer terminal 10, 11, and an ordering computer 30 identifying the right/wrong of the reception information transmitted from the orderer terminal 10, 11 judged on the basis of the reception information received from the reception computer 20 that the reception succeeds, and starts order processing when the reception information is right reception information.

### BACKGROUND OF THE INVENTION

(i) Field of the Invention

The present invention relates to a product selling system, an ordering device, an order receiving device, an order processing device, a product selling method, and a storage medium. More particularly, it relates to a product selling system, an ordering device, an order receiving device, an order processing device, a product selling method, and a storage media suitable for the case of smoothly performing order processing from many orderers via a network such as Internet.

(ii) Description of the Related Art

In recent years, online shopping to buy a product via a network such as Internet has spread. In a conventional product selling method of performing this kind of online shopping, when selling in which orders are received simultaneously from a fixed time is performed, because many orders temporarily come with a rush, errors caused by high load occur frequently. The errors of this kind temporarily concentrate and occur in each procedure even after a product is selected and order processing is started till order completion. Therefore, each procedure upon occurrence of the errors is re-executed and order processing is performed. There is a case that errors occur frequently, and, even by repeatedly performing order processing for a long time, the order is not confirmed till the order completion, thereby being unable to buy.

However, in the above-described prior art, there are the following problems.

The first problem is the point that, as described above, in selling in which orders are received simultaneously from a fixed time, even after a product is selected and order processing is started, because an error occurs in each procedure till the order completion, the orderer must repeatedly operate in the period till the order completion.

The second problem is the point that, in case that an error occurs in each procedure till the order completion, by the orderer repeating order processing, a vicious cycle making higher load arises.

### SUMMARY OF THE INVENTION

It is an object of the present invention to provide order processing devices, product selling methods, and storage media in case that orders from many orderers concentrate at a time.

In a product selling system in which ordering a product is performed via a network such as Internet, the present invention is characterized by comprising an ordering device performing ordering a product on the basis of product information and reception information, an order receiving device generating said reception information identifying an orderer in the order of reception on the basis of said product information transmitted from said ordering device, and transmitting it to said ordering device, and an order processing device identifying the right/wrong of said reception information transmitted from said ordering device judged on the basis of said reception information received from said order receiving device that the reception succeeds, and starting order processing when said reception information is right reception information.

Besides, in an order receiving device generating reception information identifying an orderer in the order of reception on the basis of product information, and an ordering device connected through a network such as Internet with an order processing device identifying the right/wrong of said reception information, and starting order processing when said reception information is right reception information, and performing ordering a product via said network, the present invention is characterized by, when it is judged on the basis of said reception information transmitted from said order receiving device that the reception succeeds, transmitting said reception information to said order processing device, and, when it is judged on the basis of order start information transmitted from said order processing device attendant upon said order processing start that the order start succeeds, performing product buying processing such as the payment method and the reception method between it and said order processing device.

Besides, in an ordering device performing ordering a product on the basis of product information and reception information, and an order receiving device connected through a network such as Internet with an order processing device identifying the right/wrong of said reception information, and starting order processing when said reception information is right reception information, and receiving the order of the product from said ordering device, the present invention is characterized by generating said reception information identifying an orderer in the order of reception on the basis of said product information transmitted from said ordering device, and transmitting it to said ordering device.

Besides, in an ordering device performing ordering a product on the basis of product information and reception information, and an order processing device connected through a network such as Internet with an order receiving device generating said reception information identifying an orderer in the order of reception on the basis of said product information, and transmitting it to said ordering device, the present invention is characterized by identifying the right/wrong of said reception information transmitted from said ordering device, starting order processing when said reception information is right reception information, and performing order processing such as the payment method and the reception method between it and said ordering device when the order start succeeds.

Besides, describing with reference to FIG. 1, in a product selling system performing ordering a product via a network (100) such as Internet, the product selling system according to the present invention comprises an ordering device (10, 11) performing ordering a product on the basis of product information and reception information, an order receiving device (20) generating said reception information identifying an orderer in the order of reception on the basis of said product information transmitted from said ordering device, and transmitting it to said ordering device, and an order processing device (30) identifying the right/wrong of said reception information transmitted from said ordering device judged on the basis of said reception information received from said order receiving device that the reception succeeds, and starting order processing when said reception information is right reception information.

### BRIEF DESCRIPTION OF THE DRAWINGS

The invention will be understood more fully from the detailed description given here below and from the accompanying drawings of preferred embodiments of the invention, which, however, should not be considered as limiting the invention but are for explanation and understanding only.

FIG. 1 is a block diagram showing an example of construction of a product selling system according to the first and second embodiments of the present invention;

FIG. 2 is a block diagram showing the concept of supplying a program of the present invention from a storage medium to each computer and each terminal constituting a product selling system according to the first to fourth embodiments of the present invention;

FIG. 3 is a flowchart showing reception/order processing in a product selling system according to the first to third embodiments of the present invention;

FIG. 4 is a block diagram showing an example of construction of a product selling system according to the third embodiment of the present invention; and

FIG. 5 is a block diagram showing an example of construction of a product selling system according to the fourth embodiment of the present invention.

Here, it should be noted that like reference numerals represent like elements throughout the disclosure.

### DETAILED DESCRIPTION OF THE PREFERRED EMBODIMENTS

The present invention is to provide a business model and a product selling business method wherein an orderer performs ordering a product via a network such as Internet, the orders are received in the order of reception, and selling is performed.

Next, the first embodiment of the present invention will be described in detail with reference to the drawings.

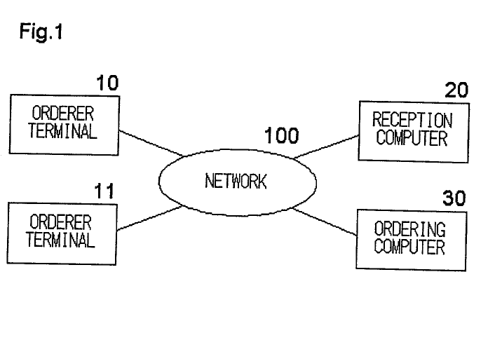

As shown in FIG. 1, a product selling system according to the first embodiment of the present invention is made up from an orderer terminal 10 owned by an orderer, an orderer terminal 11 owned by an orderer, a reception computer 20 disposed in an order receiving origin, an ordering computer 30 disposed in the order receiving origin, and a communication network (hereinafter to be referred to as network) 100 such as Internet connecting these with one another.

Describing the above construction in detail, the orderer terminal 10 is constructed as an information processing device such as a personal computer. The orderer terminal 10 has a function of accessing receivable product information that the reception computer 20 provides on the network 100, and displaying the product information on a screen. As the product information, there is information on, e.g., popular goods such as concert tickets or new model electric products, or products such as number-limited goods or period-limited goods.

Besides, the orderer terminal 10 has a function of sending out product information to order to the reception computer 20, and obtaining reception information. As the reception information, there is information on, e.g., a reception number, an orderer identifier, a product identifier, an address indicating the location of the ordering computer 30, and so on.

Further, the orderer terminal 10 has a function of accessing order information that the ordering computer 30 provides on the network 100, and displaying reception information obtained from the reception computer 20, information on the product to be ordered, and information on the order such as the payment method and the reception method on a screen, a function of inputting and selecting from input devices such as a keyboard and a pointing device, and a function of transmitting and receiving on the network 100 such as Internet.

The orderer terminal 11 represents that the orderer terminals are constituted by many orderer terminals, and is constructed as an information processing device having equivalent functions as the orderer terminal 10.

The reception computer 20 is constructed as an information processing device such as a workstation/server. The reception computer 20 has a function of receiving product information sent out from the orderer terminal 10, 11 by an operation of the orderer, and generating reception information, and transmitting it to the orderer terminal 10,

Further, the reception computer 20 has a function of, when it receives product information to order from many orderer terminals such as the orderer terminals 10, 11, generating reception information in the order of reception, and sending out it to the orderer terminals 10, 11, and so on.

Besides, the reception computer 20 has a function of generating reception information in accordance with the processing capacity of the ordering computer 30, and a function of rejecting orders more than the processing capacity of the ordering computer 30, and sending out information for demanding retry.

The ordering computer 30 is constructed as an information processing device such as a workstation/server. The ordering computer 30 receives reception information sent out from the orderer terminal 10, 11 by an operation of the orderer, judging that it is right reception information, and performing order processing.

Besides, the ordering computer 30 has a function of rejecting an order of improper reception information, and sending out information for demanding retry.

That is, in the above product selling system, the orderer sends out product information to order to the reception computer 20 using his own orderer terminal 10, 11 via the network 100. The reception computer 20 generates reception information for identifying the orderer in the order of reception, and sends out it to the orderer terminal 10, 11. Next, the orderer sends out the reception information to the ordering computer 30 using his own orderer terminal 10, 11. The orderer computer 30 identifies whether or not the reception information is right, and starts order processing. In this manner, product selling in the order of reception becomes possible.

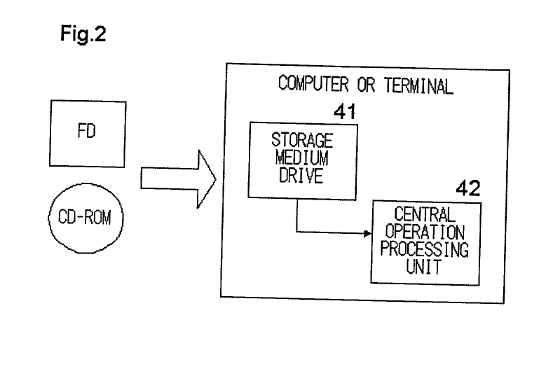

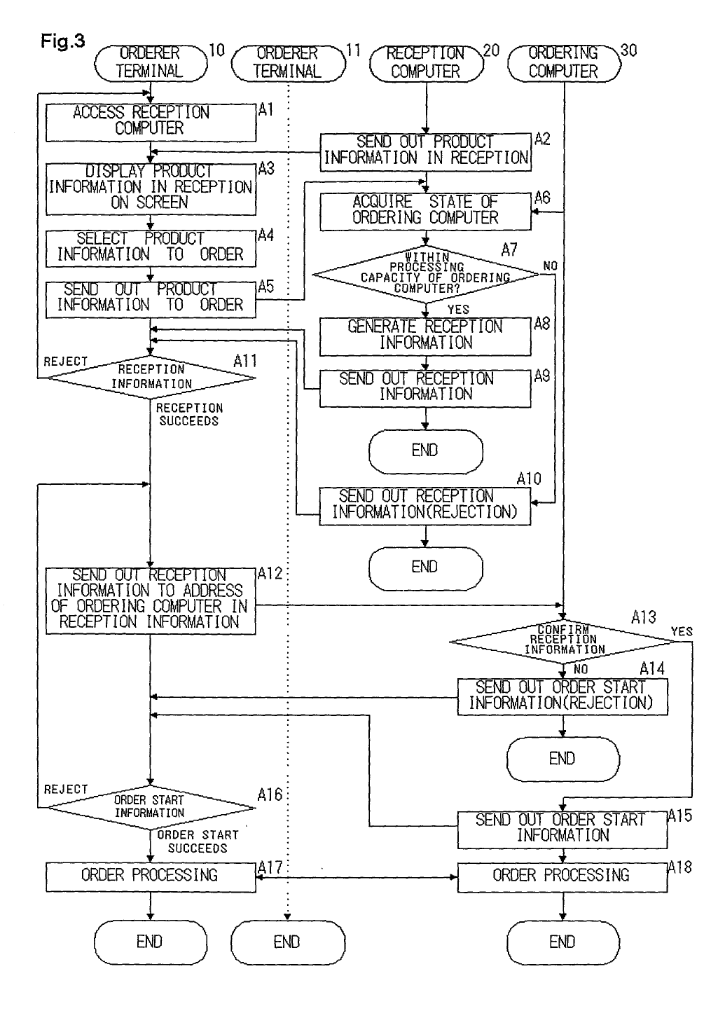

In the product selling system shown in the above FIG. 1, in case of realizing a product selling method of the present invention, as shown in FIG. 2, a storage medium such as a floppy disk or a CD-ROM storing a control program of the present invention is inserted in a storage medium drive 41 provided in each of the orderer terminal 10, the orderer terminal 11, the reception computer 20, and the ordering computer 30, and the control program is read out from the storage medium, and supplied to a central operation processing unit 42. On the basis of the supplied control program, the central operation processing unit 42 executes processing shown in the flowchart of FIG. 3. This is the same in the second to fourth embodiments described later.

Next, the operation of the first embodiment of the present invention will be described in detail with reference to FIGS. 1 and 3. In the below description, assume that the network 100 is Internet. Besides, in the below description, as the orderer terminal for performing order, the orderer terminal 10 of the orderer terminals 10, 11 is supposed.

Referring to FIG. 3, the orderer accesses a home page on the reception computer 20 via his own orderer terminal 10 (step A1). In response to this, the reception computer 20 transmits product information in reception to the orderer terminal 10 (step A2). In the orderer terminal 10, the product information in reception is displayed on a screen (step A3). The orderer determines a product to buy from the product information displayed on the orderer terminal 10, and selects the effect of ordering the product (step A4). The product information thus selected is transmitted to the reception computer 20 as product information to order (step A5).

When receiving the product information to order, the reception computer 20 acquires the state of the ordering computer (step A6), and judges whether or not it is within the processing range of the ordering computer 30 (step A7). When it is within the processing range of the ordering computer 30, reception information including a reception number, an orderer identifier, a product identifier, an address indicating the location of the ordering computer 30, and so on is generated (step A8), and the reception information is transmitted to the orderer terminal 10 (step A9). When it exceeds the processing range of the ordering computer 30, information for rejecting the reception demanding retry is transmitted to the orderer terminal 10 (step A10).

The orderer terminal 10 judges the reception information received (step A11), and, when the reception is rejected, following the instruction of retry, re-executes processing for accessing the reception computer 20 (step A1). In the judgment of the reception information (step A11), when the reception succeeds, the ordering computer address in the reception information is transmitted to the ordering computer 30 (step A12).

The ordering computer 30 judges whether the reception information received is right (step A13). In case of improper reception information, information for rejecting the order start is transmitted to the orderer terminal 10 (step 14). In case of right reception information, order start information indicating the order start is transmitted to the orderer terminal 10 (step A15).

The orderer terminal 10 judges the order start information received (step A16), and, when the order start is rejected, following the rejection contents of the order start information, retries from transmission of reception information (step A12). Judging the order start information (step A16), when the order start succeeds, communication is made between the orderer terminal 10 and the ordering computer 30, and, in order processing (step A17) and order processing (step A18), detailed processing for buying goods such as the payment method, the reception method, and so on is performed.

As described above, according to the first embodiment of the present invention, by making the reception computer 20 and the ordering computer 30 independent, and processing only orders after the reception by the reception computer 20 by the ordering computer 30, because it can be prevented that many orders concentrate to the ordering computer 30 and order processing can not be performed, in case that orders from many orderers concentrates at a time, there is an effect that order processing can be smoothly performed.

Next, the second embodiment of the present invention will be described with reference to the drawings.

Like the above first embodiment, a product selling system according to the second embodiment of the present invention is made up from an orderer terminal 10 owned by an orderer, an orderer terminal 11 owned by an orderer, a reception computer 20 disposed in an order receiving origin, an ordering computer 30 disposed in the order receiving origin, and a network 100 such as Internet connecting these with one another (see the above FIG. 1). Since the construction of each part of the product selling system has been described in detail in the above first embodiment, the description is omitted.

Next, the operation of the second embodiment of the present invention will be described in detail with reference to FIGS. 1 and 3. In the below description, as the orderer terminal for performing order, the orderer terminal 10 of the orderer terminals 10, 11 is supposed.

The second embodiment of the present invention differs from the above first embodiment on the point that, in reception information generation (step A7) and reception information sending-out (step A8) of FIG. 3, an order start time is added in reception information. The operation till the reception computer 20 acquires the state of the ordering computer 30 (step A6) is the same as the operation of the above first embodiment.

In the judgment of the processing capacity of the ordering computer (step A7), the reception computer 20 calculates an order start time from the state of the ordering computer 30, and judges an order within a certain time to be within the processing capacity of the ordering computer 30. The calculation of the order start time is made by dividing the number of unsettled orders (the number that the number of settled orders is subtracted from the number of receptions) by the number of orders that the ordering computer can process in a unit of time (e.g. ten minutes). For example, in case that the ordering computer can process 20 orders in ten minutes, when there are 60 unsettled orders, 30 minutes are required till the order start, and the order start time is the present time plus 30 minutes. In generation of reception information (step A8), the time that the order can start is added to the reception information. The reception computer 20 transmits the reception information to which the order start time is added to the orderer terminal 10 (step A9).

The orderer terminal 10 judges the reception information received from the reception computer 20 (step A11), and, when the reception succeeds, transmits the reception information to the ordering computer 30 on the basis of the order start time in the reception information (step A12).

In confirmation of the reception information received from the orderer terminal 10 (step A13), the ordering computer 30 judges with including the order start time. The subsequent processing is the same as the operation of the above first embodiment.

As described above, according to the second embodiment of the present invention, by calculating the order start time, and issuing reception information in order, there is an effect that the number of times of rejecting the receptions is decreased, and more requirements of order desiring persons than those in the above first embodiment can be received.

Next, the third embodiment of the present invention will be described in detail with reference to the drawings.

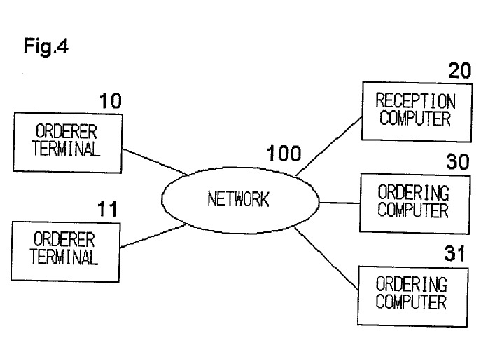

As shown in FIG. 4, a product selling system according to the third embodiment of the present invention is made up from an orderer terminal 10 owned by an orderer, an orderer terminal 11 owned by an orderer, a reception computer 20 disposed in an order receiving origin, a plurality of ordering computer 30 and ordering computer 31 disposed in the order receiving origin, and a network 100 such as Internet connecting these with one another.

That is, the third embodiment of the present invention differs from the above first embodiment on the point that the ordering computers are constructed by a plurality of ordering computers. The ordering computer 30 and the ordering computer 31 indicates that the ordering computers are constructed by two or more computers.

Next, the operation of the third embodiment of the present invention will be described in detail with reference to FIGS. 3 and 4. In the below description, as the orderer terminal for performing order, the orderer terminal 10 of the orderer terminals 10, 11 is supposed.

In the third embodiment of the present invention, in processing of FIG. 3, the operation till the orderer terminal 10 transmits product information to the reception computer 20 (step A5) is the same as that of the above first embodiment.

In acquisition of the state of the ordering computer (step A6), the reception computer 20 acquires the states of a plurality of ordering computers of the ordering computer 30, the ordering computer 31, and so on. The reception computer 20 judges the processing capacity of the ordering computers as the sum of a plurality of ordering computers (step A7). when generating reception information, in order that there is no deviation in the loads of a plurality of ordering computers, addresses indicating the locations of the ordering computers in the reception information are dispersed and generated (step A8). The reception computer 20 transmits reception information in which the address indicating the location of the ordering computer differs per reception, to the orderer terminal 10 (step A9).

The orderer terminal 10 executes the subsequent order procedures on the basis of the reception information received. The subsequent operation is the same as that of the above first embodiment.

The third embodiment of the present invention can be combined with the above second embodiment.

As described above, according to the third embodiment of the present invention, by disposing a plurality of ordering computers, and assigning ordering computers upon reception, there is an effect that the loads of the ordering computers are dispersed, and processing in accordance with the number of ordering computers can be performed.

Next, the fourth embodiment of the present invention will be described in detail with reference to the drawings.

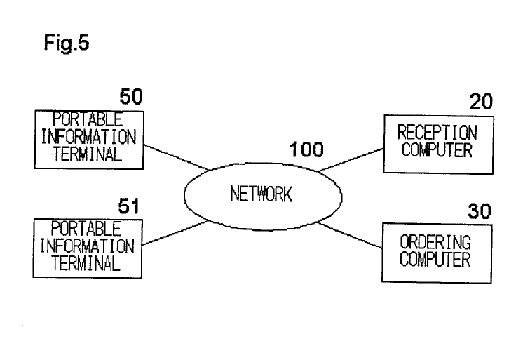

As shown in FIG. 5, a product selling system according to the fourth embodiment of the present invention is made up from a portable information terminal 50 owned by an orderer, a portable information terminal 51 owned by an orderer, a reception computer 20 disposed in an order receiving origin, an ordering computer disposed in the order receiving origin, and a network 100 such as Internet connecting these with one another.

That is, the fourth embodiment of the present invention differs from the above first embodiment on the point that the orderer uses the portable information terminal 50, 51 such as a portable telephone having a communication function and an information processing function, as the orderer terminal.

The operation of the fourth embodiment of the present invention is the operation in which the orderer terminal 10, 11 is replaced by the portable information terminal 50, 51 in processing shown in the above FIG. 3. The fundamental operation is the same as the operation of the above first embodiment.

The fourth embodiment of the present invention can be combined with the above second embodiment, the above third embodiment.

As described above, according to the fourth embodiment of the present invention, like the above first embodiment, in case that orders from many orderers concentrate at a time, there is an effect that order processing can be smoothly performed.

As described above, according to the present invention, by generating reception information for identifying an orderer in the order of reception on the basis of product information transmitted from an ordering device, and transmitting it to the ordering device, by an order receiving device, and identifying the right/wrong of the reception information transmitted from the ordering device judged on the basis of the reception information received from the ordering device that the reception succeeds, and starting order processing in case that the reception information is right reception information, by an order processing device, that is, by making the order receiving device and the order processing device independent, and processing only the orders after reception from the ordering device in the order receiving device, by the order processing device, because it can be prevented that many orders concentrate to the order processing device and order processing can not be performed, in case that orders from many orderers concentrate at a time, there is an effect that order processing can be smoothly performed.

Although the invention has been described in detail above in connection with various preferred embodiments thereof, it will be appreciated by those skilled in the art that these embodiments have been provided solely for purpose of illustration, and are in no way to be considered as limiting the invention. Instead, various modifications and substitutions of equivalent techniques will be readily apparent to those skilled in the art upon reading this specification, and such modifications and substitutions are to be considered as falling within the true scope and spirit of the following claims.

What is claimed is:

1. A product selling system in which ordering a product is performed via a network such as Internet, comprising the following constructions:
an ordering device performs ordering a product on the basis of product information and reception information;
an order receiving device generates said reception information identifying an orderer in the order of reception on the basis of said product information received from said ordering device, and transmits it to said ordering device; and
an order processing device identifies the right/wrong of said reception information transmitted from said ordering device judged on the basis of said reception information received from said ordering device that the reception succeeds, and starts order processing when said reception information is right reception information.

2. The product selling system claimed in claim 1, further comprising the following construction:
said ordering device performs ordering a product on the basis of product information including information on products of, at least, popular goods, number-limited goods, period-limited goods, and tickets, and reception information including information on, at least, reception number, orderer identifier, product identifier, address indicating the location of said order processing device, and so on, judges order start information transmitted from said order processing device attendant upon said order processing start, and performs product buying processing of a payment method and a reception method between it and said order processing device when the order start succeeds.

3. The product selling system claimed in claim 2, further comprising the following constructions:
said order receiving device calculates an order start time on the basis of the state of said order processing device, and transmits said order start time with being added to said reception information to said ordering device;
when judging on the basis of said reception information received from said order receiving device that the reception succeeds, said ordering device transmits said reception information to said order processing device on the basis of said order start time added to said reception information; and
said order processing device identifies the right/wrong of said reception information transmitted from said ordering device in consideration of said order start time, and starts order processing when said reception information is right reception-information.

4. The product selling system claimed in any of claims 1 to 3, further comprising the following constructions:
a plurality of said order processing devices are disposed; and
taking the processing capacity of said each order processing device into consideration, in order not to generate deviation in the load of said each order processing device, said order receiving device disperses and generates the addresses indicating the locations of said order processing devices in said reception information, and transmits them to said ordering device.

5. The product selling system claimed in any of claims 1 to 4, further comprising the following construction:
said ordering device is a portable information terminal including a portable telephone having a communication function and an information processing function.

6. An ordering device connected through a network such as Internet with an order receiving device generating reception information identifying an orderer in the order of reception on the basis of product information, and an order processing device identifying the right/wrong of said reception information, and starting order processing when said reception information is right reception information, and performing ordering a product via said network, comprising the following construction:
said ordering device transmits said reception information to said order processing device when it judges on the basis of said reception information transmitted from said order receiving device that the reception succeeds, and performs product buying processing of payment method and reception method between it and said order processing device when it judges on the basis of order start information transmitted from said order processing device attendant upon order processing start that the order start succeeds.

7. An order receiving device connected through a network such as Internet with an ordering device performing ordering a product on the basis of product information and reception information, and an order processing device identifying the right/wrong of said reception information, and starting order processing when said reception information is right reception information, and receiving an order of a product from said ordering device, comprising the following construction:
said order receiving device generates said reception information identifying an orderer in the order of reception on the basis of said product information transmitted from said ordering device, and transmits it to said ordering device.

8. An order processing device connected through a network such as Internet with an ordering device performing ordering a product on the basis of product information and reception information, and an order receiving device generating said reception information identifying an orderer in the order of reception on the basis of said product information, and transmitting it to said ordering device, and processing an order of a product from said ordering device, comprising the following construction:
said order processing device identifies the right/wrong of said reception information transmitted from said ordering device, starts order processing when said reception information is right reception information, and performs order processing of a payment method, a reception method, and so on between it and said ordering device when the order start succeeds.

9. A product selling method in which ordering a product is performed via a network such as Internet, comprising the following construction:
said product selling method is that an order receiving device generates reception information identifying an orderer in the order of reception on the basis of product information transmitted from an ordering device, said ordering device transmits said reception information to said order processing device when it judges on the basis of said reception information transmitted from said order receiving device that the reception succeeds, and said order processing device identifies the right/wrong of said reception information transmitted from said ordering device, starts order processing when said reception information is right reception information, and performs product buying processing of a payment method, a reception method, and so on between said ordering device and said order processing device.

10. An ordering method connected through a network such as Internet with an order receiving device generating reception information identifying an orderer in the order of reception on the basis of product information, and an order processing device identifying the right/wrong of said reception information, and starting order processing when said reception information is right reception information, and performing ordering a product via said network, comprising the following construction:
said ordering method transmits said reception information to said order processing device when it judges on the basis of said reception information transmitted from said order receiving device that the reception succeeds, and performs product buying processing of payment method and reception method between it and said order processing device when it judges on the basis of order start information transmitted from said order processing device attendant upon order processing start that the order start succeeds.

11. An order receiving method connected through a network such as Internet with an ordering device performing ordering a product on the basis of product information and reception information, and an order processing device identifying the right/wrong of said reception information, and starting order processing when said reception information is right reception information, and receiving an order of a product from said ordering device, comprising the following construction:
said order receiving method generates said reception information identifying an orderer in the order of reception on the basis of said product information transmitted from said ordering device, and transmits it to said ordering device.

12. An order processing method connected through a network such as Internet with an ordering device performing ordering a product on the basis of product information and reception information, and an order receiving device generating said reception information identifying an orderer in the order of reception on the basis of said product information, and transmitting it to said ordering device, and processing an order of a product from said ordering device, comprising the following construction:
said order processing method identifies the right/wrong of said reception information transmitted from said ordering device, starts order processing when said reception information is right reception information, and performs order processing of a payment method, a reception method, and so on between it and said ordering device when the order start succeeds.

13. A recording medium recording a program enabling the following processing:
processing that an order receiving device generates reception information identifying an orderer in the order of reception on the basis of product information transmitted from an ordering device;
processing that said ordering device transmits said reception information to said order processing device when it judges on the basis of said reception information transmitted from said order receiving device that the reception succeeds;
processing that said order processing device identifies the right/wrong of said reception information transmitted from said ordering device, and starts order processing when said reception information is right reception information; and
processing of performing product buying processing of a payment method, a reception method, and so on between said ordering device and said order processing device.

14. A recording medium recording a program enabling the following processing:
ordering processing connected through a network such as Internet with an order receiving device generating reception information identifying an orderer in the order of reception on the basis of product information, and an order processing device identifying the right/wrong of said reception information, and starting order processing when said reception information is right reception information, and performing ordering a product via said network, comprising the following construction:
said ordering processing transmits said reception information to said order processing device when it judges on the basis of said reception information transmitted from said order receiving device that the reception succeeds, and performs product buying processing of payment method and reception method between it and said order processing device when it judges on the basis of order start information transmitted from said order processing device attendant upon order processing start that the order start succeeds.

15. A recording medium recording a program enabling the following processing:
order receiving processing connected through a network such as Internet with an ordering device performing ordering a product on the basis of product information and reception information, and an order processing device identifying the right/wrong of said reception information, and starting order processing when said reception information is right reception information, and receiving an order of a product from said ordering device, comprising the following construction:
said order receiving processing generates said reception information identifying an orderer in the order of reception on the basis of said product information transmitted from said ordering device, and transmits it to said ordering device.

16. A recording medium recording a program enabling the following processing:
order processing connected through a network such as Internet with an ordering device performing ordering a product on the basis of product information and reception information, and an order receiving device generating said reception information identifying an orderer in the order of reception on the basis of said product information, and transmitting it to said ordering device, and processing an order of a product from said ordering device, comprising the following construction:
said order processing identifies the right/wrong of said reception information transmitted from said ordering device, starts order processing when said reception information is right reception information, and performs order processing of a payment method, a reception method, and so on between it and said ordering device when the order start succeeds.

17. A group of recording media, wherein said program claimed in claim 13 is divided into a plurality of portions and said portions are recorded on said media, respectively.

18. A group of recording media, wherein said program claimed in claim 14 is divided into a plurality of portions and said portions are recorded on said media, respectively.

19. A group of recording media, wherein said program claimed in claim 15 is divided into a plurality of portions and said portions are recorded on said media, respectively.

20. A group of recording media, wherein said program claimed in claim 16 is divided into a plurality of portions and said portions are recorded on said media, respectively.

21. A program embodied as an electric signal to enable the following processing:
processing that an order receiving device generates reception information identifying an orderer in the order of reception on the basis of product information transmitted from an ordering device;
processing that said ordering device transmits said reception information to said order processing device when it judges on the basis of said reception information transmitted from said order receiving device that the reception succeeds;
processing that said order processing device identifies the right/wrong of said reception information transmitted from said ordering device, and starts order processing when said reception information is right reception information; and
processing of performing product buying processing of a payment method, a reception method, and so on between said ordering device and said order processing device.

22. A program embodied as an electric signal to enable the following processing:
ordering processing connected through a network such as Internet with an order receiving device generating reception information identifying an orderer in the order of reception on the basis of product information, and an order processing device identifying the right/wrong of said reception information, and starting order processing when said reception information is right reception information, and performing ordering a product via said network, comprising the following construction:
said ordering processing transmits said reception information to said order processing device when it judges on the basis of said reception information transmitted from said order receiving device that the reception succeeds, and performs product buying processing of payment method and reception method between it and said order processing device when it judges on the basis of order start information transmitted from said order processing device attendant upon order processing start that the order start succeeds.

23. A program embodied as an electric signal to enable the following processing:
order receiving processing connected through a network such as Internet with an ordering device performing ordering a product on the basis of product information and reception information, and an order processing device identifying the right/wrong of said reception information, and starting order processing when said reception information is right reception information, and receiving an order of a product from said ordering device, comprising the following construction:
said order receiving processing generates said reception information identifying an orderer in the order of reception on the basis of said product information transmitted from said ordering device, and transmits it to said ordering device.

24. A recording medium recording a program enabling the following processing:
order processing connected through a network such as Internet with an ordering device performing ordering a product on the basis of product information and reception information, and an order receiving device generating said reception information identifying an orderer in the order of reception on the basis of said product information, and transmitting it to said ordering device, and processing an order of a product from said ordering device, comprising the following construction:
said order processing identifies the right/wrong of said reception information transmitted from said ordering device, starts order processing when said reception information is right reception information, and performs order processing of a payment method, a reception method, and so on between it and said ordering device when the order start succeeds.
